(19) United States
(12) Patent Application Publication
(10) Pub. No.: US 2010/0115633 A1
(43) Pub. Date: May 6, 2010

(54) IMAGE FORMING APPARATUS AND SOFTWARE ENABLING METHOD THEREOF

(75) Inventors: Sung-hyun RYU, Seoul (KR); Jae-young LEE, Jeonju-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/608,229

(22) Filed: Oct. 29, 2009

(30) Foreign Application Priority Data
Oct. 30, 2008 (KR) 2008-107364

(51) Int. Cl. G06F 21/00

(52) U.S. Cl. 726/31; 726/33

(57) ABSTRACT

A method of enabling software installed in an image forming apparatus, and an image forming apparatus to perform the method, the method including connecting a first license device having at least one license which can enable the software to the first image forming apparatus; enabling the software using the at least one license; reconnecting the first license device to the first image forming apparatus; and disabling the enabled software.

### CROSS-REFERENCE TO RELATED APPLICATIONS

This application claims the benefit under 35 U.S.C. §119(a) of Korean Patent Application No. 10-2008-0107364, filed on Oct. 30, 2008, in the Korean Intellectual Property Office, the disclosure of which is incorporated herein by reference in its entirety.

### BACKGROUND

1. Field of the Invention

Methods and devices consistent with the present general inventive concept relate to an image forming apparatus and a software enabling method thereof, and more particularly, to an image forming apparatus and a software enabling method thereof which are capable of using a license device storing a software license multiple times.

2. Description of the Related Art

An image forming apparatus is an apparatus which prints a desired image on a print medium. Examples of such a device include a printer, a copy machine, a multifunction copier, etc.

In recent years, advanced image forming apparatuses having storing units in which software is stored in an inactive state have come into the market. When a user purchases a license to use the software, a license key which stores the license, such as a USB memory type, is provided to the user. When the user inserts the provided license key in an interface of an image forming apparatus, the software is enabled to allow the user to use the software.

However, once the license key has been inserted in the image forming apparatus and the software of the image forming apparatus has been enabled, the license key cannot be used any longer. In addition, if the image forming apparatus having the enabled software is repaired, the license key does not work any longer after the repair, thereby preventing the software from being used in the repaired image forming apparatus.

### SUMMARY

Example embodiments of the present general inventive concept provide an image forming apparatus and a software enabling method thereof which are capable of using a license device storing a software license multiple times.

Another feature of the present general inventive concept is to provide an image forming apparatus and a software enabling method thereof which are capable of improving a user's convenience.

Additional features and utilities of the present general inventive concept will be set forth in part in the description which follows and, in part, will be obvious from the description, or may be learned by practice of the present general inventive concept.

The foregoing and/or other features and utilities of the present general inventive concept may be achieved by providing a method of enabling software installed in a first image forming apparatus, the method including connecting a first license device having at least one license which enables the software to the first image forming apparatus; enabling the software using the at least one license; reconnecting the first license device to the first image forming apparatus; and disabling the enabled software.

The enabling the software and/or the disabling the enabled software may be performed according to a user's selection.

The method may further include enabling software installed in a second image forming apparatus in response to the first license device being connected to the second image forming apparatus.

An allowed number of times of the enabling and disabling of the software may be previously determined.

The method may further include prompting a user to choose whether to enable or disable the software.

The method may further include disabling the license corresponding to the enabled software in response to the enabling of the software.

The method may further include restoring the disabled license corresponding to the disabled software in response to the disabling the software.

The disabling the license may include storing proper information of the first image forming apparatus in the license device.

The restoring the disabled license may include deleting the stored proper information of the first image forming apparatus.

The method may further include notifying a user of a remaining number of times of which the license may be restored.

The method may further include registering proper information of the first image forming apparatus having the enabled software with an external license registration server via a network.

The method may further include outputting an error notification and maintaining an enabled state of the software in response to a second license device being connected to the first image forming apparatus.

The foregoing and/or other features and utilities of the present general inventive concept may also be achieved by providing a method of enabling software installed in a first image forming apparatus, the method including connecting a first license device having a plurality of licenses which enable a plurality of software applications to the first image forming apparatus; enabling one or more of the plurality of software applications; reconnecting the first license device to the first image forming apparatus; and disabling at least one of the enabled one one or more software applications.

The enabling one or more of the plurality of software applications may include outputting information related to the plurality of software applications; receiving a selection of the one or more of the plurality of software applications; and enabling the selected software applications.

The disabling at least one of the enabled one or more software applications may include outputting information related to the one or more enabled software applications; receiving a selection of the at least one of the enabled one or more software applications to be disabled; and disabling the selected at least one software application.

The method may further include restoring the license corresponding to the disabled software application.

The method may further include indicating enabled and disabled states of the plurality of software applications.

The foregoing and/or other features and utilities of the present general inventive concept may also be achieved by providing an image forming apparatus which enables software using a license device, including an interface to which the license device can be connected; a storing unit which stores the software; and a controller which enables the software stored in the storing unit in response to a license device having a license to enable the software being connected to the interface, and which disables the enabled software in response to the license device being reconnected to the interface.

The apparatus may further include an input unit to allow a user to select whether to enable or disable the software.

The enabling or disabling of the software may be disallowed in response to a number of instances of enabling or disabling the software exceeding a previously determined limit.

The apparatus may further include a notification unit to prompt a user to choose whether to enable or disable the software.

The controller may disable the license in response to the software being enabled, and may restore the disabled license in response to the enabled software being disabled.

The controller may store proper information of the image forming apparatus in the license device in order to disable the license.

The controller may delete the proper information of the image forming apparatus stored in the license device in order to restore the disabled license.

The apparatus may further include a notification unit to notify a user as to how many remaining instances of enabling or disabling the software will be allowed.

The apparatus may further include a network connection unit to transmit proper information of the image forming apparatus having the enabled software to an external license registration server.

The apparatus may further include a notification unit to output an error notification in response to a different license device being connected to the image forming apparatus, wherein the controller may maintain the enabled state of the software along with controlling the notification unit to output the error notification.

The foregoing and/or other features and utilities of the present general inventive concept may also be achieved by providing an image forming apparatus which enables at least one of a plurality of software applications using a license device, including an interface to which the license device can be connected; a storing unit to store the plurality of software applications; and a controller to enable one or more of the software applications in response to a license device having one or more licenses corresponding to the software applications being connected to the interface, and to disable one or more of the enabled software applications in response to the license device being reconnected to the interface.

The foregoing and/or other features and utilities of the present general inventive concept may also be achieved by providing a recording medium having recorded thereon a program to cause a computer to perform a method of enabling software installed in an image forming apparatus, the method including connecting a license device having at least one license which enables the software to the image forming apparatus; enabling the software using the at least one license; reconnecting the license device to the image forming apparatus; and disabling the enabled software.

The foregoing and/or other features and utilities of the present general inventive concept may also be achieved by providing a method of enabling software installed in an image forming apparatus, the method including enabling the software in response to a license device being connected to the image forming apparatus; and disabling the software in response to the license device being reconnected to the image forming apparatus.

The method may further include disabling a license in the license device in response to enabling the software.

The disabling the license may include storing proper information of the image forming apparatus in the license device so as to correspond to the disabled license.

The method may further include restoring a license in the license device in response to disabling the software.

The restoring the license may include restoring indicating information initially recorded in the license device to indicate that the license is enabled.

The method may further include storing enable information read from the license device in the image forming apparatus to enable the software after the license device is disconnected.

The method may further include erasing the enable information stored in the image forming apparatus in response to the software being disabled.

The method may further include comparing the enable information stored in the image forming apparatus with the enable information stored in the reconnected license device to confirm that the reconnected license device is the license device initially connected to the image forming apparatus.

The method may further include maintaining the enabled software in response to the enable information stored in the image forming apparatus not corresponding to the enable information stored in the reconnected license device.

The method may further include notifying a user that the reconnected license device is not the license device initially connected to the image forming apparatus.

The method may further include storing a predetermined value indicating an amount of times which the license device may enable the software.

The method may further include adjusting the stored predetermined value each time the software is enabled by the license device.

The method may further include displaying a number of times of which the enabling of the software will be allowed according to the adjusted value.

The method may further include transmitting enable information regarding the enabled software and the image forming apparatus through a network to a registration server.

The foregoing and/or other features and utilities of the present general inventive concept may also be achieved by providing a method of controlling software in an apparatus, the method including enabling the software in response to a license device having a license to enable the software being connected to the apparatus; and disabling the license in the license device.

The disabling the license may include storing identification information of the apparatus on the license device.

The foregoing and/or other features and utilities of the present general inventive concept may also be achieved by providing a method of controlling software in an apparatus, the method including disabling the software in response to a license device having a disabled license corresponding to the software; and restoring the license in the license device.

The restoring the license may include deleting identification information of the apparatus recorded on the license device.

The image forming apparatus and the software enabling method thereof according to the present general inventive concept have the following advantages.

A user can flexibly utilize software licenses of an image forming apparatus. In particular, even when a broken image forming apparatus is repaired, software applications which have been previously used can be used again after the repair.

Also, because a software license can be moved from one image forming apparatus to another depending on a user's selection, the user's convenience is improved.

Additionally, a license device storing software licenses can be used several times.

### BRIEF DESCRIPTION OF THE DRAWINGS

The above and/or other features and advantages of the present general inventive concept will become apparent and more readily appreciated from the following description of various exemplary embodiments, taken in conjunction with the accompanying drawings of which:

FIG. 1 is a schematic perspective view illustrating an image forming apparatus according to an exemplary embodiment of the present general inventive concept.

FIG. 2 is a block diagram illustrating the image forming apparatus of FIG. 1.

FIG. 3 is a flow chart illustrating a software enabling method of an image forming apparatus according to an exemplary embodiment of the present general inventive concept.

FIG. 4 is a flow chart illustrating a software enabling method of an image forming apparatus according to another exemplary embodiment of the present general inventive concept.

FIGS. 5a and 5b are flow charts illustrating a software enabling method of an image forming apparatus according to yet another exemplary embodiment of the present general inventive concept.

FIG. 6 is a flow chart illustrating a software enabling method of an image forming apparatus according to still another exemplary embodiment of the present general inventive concept.

### DETAILED DESCRIPTION OF THE EMBODIMENTS

Reference will now be made in detail to various exemplary embodiments of the present general inventive concept, examples of which are illustrated in the accompanying drawings, so that those in the art can easily practice the present general inventive concept. The present general inventive concept is not limited to the exemplary embodiments disclosed herein, and may be implemented in different forms.

Hereinafter, an image forming apparatus and a software enabling method thereof according to exemplary embodiments of the present general inventive concept will be described in detail with reference to the accompanying drawings, wherein like reference numerals refer to like elements throughout.

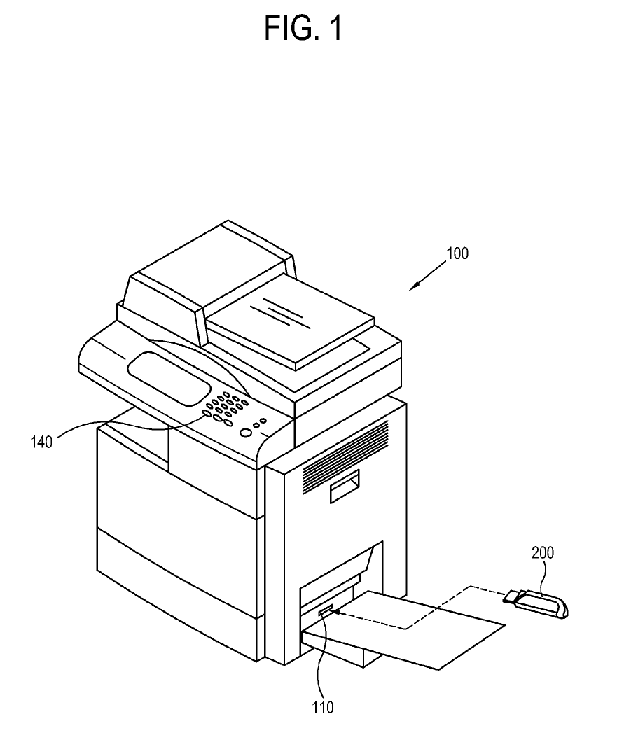

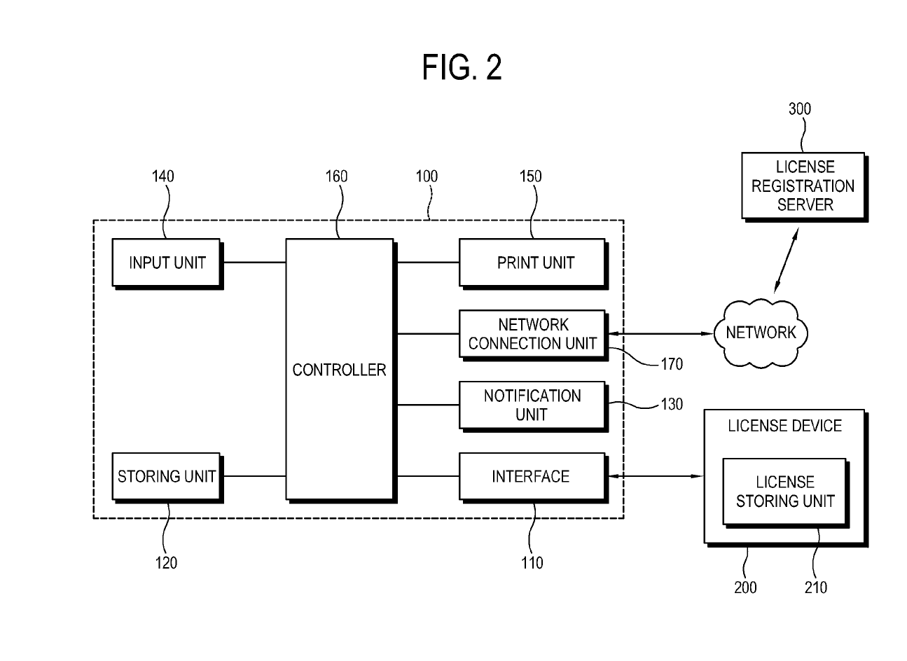

FIG. 1 is a schematic perspective view illustrating an image forming apparatus according to an exemplary embodiment of the present general inventive concept, and FIG. 2 is a block diagram illustrating the image forming apparatus of FIG. 1. As illustrated in FIGS. 1 and 2, an image forming apparatus 100 of the present general inventive concept may include an interface 110 to which a license device 200 which stores one or more software licenses may be connected, a storing unit 120 which may store at least one software application (i.e., machine-readable processor instructions) enabled by a software license stored on the license device 200, and a controller 160. The terms “software” and “software application(s)” may be used interchangeably throughout this description, and will be understood by those skilled in the art to refer to the aforementioned processor instructions.

The license device 200 may include a license storing unit 210 which stores proper information of the image forming apparatus 100, which is activated by the license of software, as apparatus proper information. The apparatus proper information will be discussed in more detail later in this description.

The license storing unit 210 may include an EEPROM (Electrically Erasable Programmable Read-Only Memory), which is capable of reading/writing information multiple times, a flash memory, or other types of storage or combinations thereof. More particularly, in addition to the above-mentioned storage types, the license storing unit 210 may be implemented by various types of memories as long as they can read/write the proper information of the image forming apparatus 100 multiple times.

The license stored on the license device 200 may enable the at least one software application stored in the storing unit 120 of the image forming apparatus 100 and may include at least one of the apparatus proper information and enabling information, which will be described later. The apparatus proper information may be stored with an initial value in the license storing unit 210 at the time of first purchase (or otherwise legitimate obtaining) of the license device 200, and thereafter the initial value may be replaced with the proper information of the image forming apparatus 100 at the time of license exhaustion (license disabling) which will be described later.

In one embodiment of the present general inventive concept, one license may be provided to enable one software application, or in another embodiment, one license may be provided to enable a plurality of software applications.

In addition, enabling information related to software to be enabled may be stored in the license storing unit 210. In some embodiments, it may be preferable that the enabling information of the software be stored in an OTP (One Time Programmable) EEPROM or an unmodifiable ROM so that a user cannot modify the enabling information.

For example, data of a format as shown in the following Table 1 may be stored in the license storing unit 210.

TABLE 1

| Data | Size (bytes) | Description | Initial value |
|---|---|---|---|
| Production | 4 | Production | Production |
| date | | year/month/date | year/month/date |
| Apparatus | 16 | Apparatus | 0 (zero) |
| proper | | identification | |
| information | | number | |
| | | (Serial number) | |
| Enabling | 64 | 0: Disabled | |
| information | | 1: Enabled | |
| (Option | | | |
| information) | | | |

The enabling information may be stored with the initial value in association with the software enabled by the license device 200, details of which will be described later.

The interface 110 may be provided to conduct data communication with the license device 200. If the license device 200 is provided in a USB (Universal Serial Bus) configuration, the interface 110 may employ the USB configuration accordingly. Additionally, data may be coded and exchanged between the interface 110 and the license device 200.

Upon detecting that the license device 200 is connected to the interface 110, the controller 160 may determine whether or not the license device 200 has a license to enable the software stored in the storing unit 120 of the image forming apparatus 100.

The controller 160 may determine whether or not the license is present according to whether an apparatus identification number (for example, the serial number of the apparatus), which may be one of the data values stored in the license storing unit 210 of the license device 200, is an initial value. For example, if the apparatus identification number stored in the license storing unit 210 is the initial value (e.g., 0, zero), it may be determined that there exists a license, and if the apparatus identification number is not the initial value, it may be determined that the license is exhausted. That is, it may be determined that the license of the license device 200 is disabled and is no longer valid to enable the software stored in the storing unit 120 of the image forming apparatus 100.

In some cases, contrary to the determination of the presence of the license described above, the controller 160 may determine that the license is present if the apparatus identification number stored in the license storing unit 210 of the license device 200 is equal to the proper information of the image forming apparatus 100 and may determine that the license is exhausted if the apparatus identification number is the initial value. It should be understood that the above-described method of determining the presence of the license stored in the license storing unit 210 of the license device 200 may be modified in various ways.

If the license device 200 in which the software license is present, that is, not disabled, is connected to the interface 110, the controller 160 enables the software stored in the storing unit 120 of the image forming apparatus 100 and exhausts the software license of the license device 200. That is, the license of the software is disabled in the license device 200 in response to the software being enabled in the image forming apparatus 100.

In the case in which the proper information of the image forming apparatus 100 in which the software is enabled is stored in the license storing unit 210 of the license device 200, the software license may be exhausted (disabled so as not to further enable any software).

In this embodiment, the proper information of the image forming apparatus 100 may refer to identification information that distinguishes the image forming apparatus 100 having the enabled software from other image forming apparatuses and may be a serial number issued to each image forming apparatus 100 at the time of fabrication, shipping, etc., of the products. In some cases, the proper information may be an IP address of the image forming apparatus 100 or a MAC (Media Access Control) address of a network interface card provided to directly connect the image forming apparatus 100 to a network. More specifically, the proper information of the image forming apparatus 100 may be unique to only that one image forming apparatus 100, so as to differentiate that one apparatus from other apparatuses.

In addition to exhausting the license of the software, the controller 160 may enable the software in the image forming apparatus 100 by storing the enabling information of the enabled software in the storing unit 120 of the image forming apparatus 100. If all software licenses which can be enabled by the license device 200 are enabled in the image forming apparatus 210, the enabling information stored in the license storing unit 210 of the license device 200 may be stored, as it is stored in the license storing unit 210, in the storing unit 120 of the image forming apparatus 100.

For example, if the license device 200 has a license to enable all software applications “A,” “B” and “C” and accordingly all “A,” “B” and “C” software applications are enabled in the image forming apparatus 100, the enabling information (e.g., a data value of “111”) stored in the license device 200 may be stored, as it may be initially stored in the license storing unit 210, in the storing unit 120 of the image forming apparatus 100. In this case, each respective value sequentially represented in “111” may indicate the enabling or lack of enabling (exhausted) of the “A,” “B” and “C” software applications in order, wherein “1” indicates an enabled state and “0” indicates a disabled state. In other words, the first “1” in “111” may indicate a license to enable software application “A”, the second “1” in “111” may indicate a license to enable software application “B”, and the third “1” in “111” may indicate a license to enable software application “C”. Conversely, if any of the values is “0”, rather than “1”, the corresponding software application may not be enabled. It is understood that this is merely one example of a configuration of the enabling information, and the present general inventive concept is not limited thereto.

Accordingly, since the enabling or lack thereof can be known by referring to the enabling information of the “A,” “B” and “C” software applications stored in the image forming apparatus 100, the enabling or lack thereof of the software can be determined itself without referring to the license device 200 even when the license device 200 is disconnected from the interface 110.

On the other hand, if the license device 200 in which the software license is exhausted, that is, disabled from enabling the corresponding software, is connected to the interface 110, the controller 160 may disable the software which has been previously enabled in the image forming apparatus 100 and may restore the software license to the license device 200. That is, instead of only disabling the software of the image forming apparatus, the disabled license may also be restored to a usable state.

In more detail, if it is detected that the license device 200 is connected to the interface 110 and if the apparatus identification number stored in the license storing unit 210 of the license device 200 is not the initial value, the controller 160 may determine that the software license of the license device 200 is exhausted. In this case, the controller 160 may disable the software, which has been enabled by the license device, in the image forming apparatus 100 and may delete the proper information of the image forming apparatus 100, that is, the apparatus identification number stored in the license storing unit 210 of the license device 200. As the proper information of the image forming apparatus 100 is deleted and the apparatus identification number is restored to the original initial value, the license of software of the license device 200 can be restored to a usable state.

In such an operation, the software previously enabled in the image forming apparatus 100 can be disabled by updating the enabling information stored in the storing unit 120 in correspondence to the disabling of the software.

For example, if all of the “A,” “B” and “C” software applications are disabled, the enabling information (“111”) stored in the storing unit 120 may be updated and stored as enabling information (“000”) of an initial disabled state in the storing unit 120.

As another example, if only the “A” software of the enabled “A,” “B” and “C” software applications is to be changed to a disabled state, by updating the enabling information (“111”) stored in the storing unit 120 to “011” accordingly and storing it in the storing unit 120, only the “A” software may be disabled.

As described above, a user can restore the software license of the license device 200 which has been previously exhausted. In addition, the user may use the license device 200 having the restored license to again grant the license to the image forming apparatus 100 in a situation such as, for example, after repair of the image forming apparatus 100 and, in some cases, to grant the license to other separate image forming apparatuses.

In the meantime, as occasion demands, if the license device 200 whose software license is exhausted is connected to the interface 110 prior to disabling the software and restoring the license as described above, the controller 160 may first determine whether the connected license device 200 is the same one used previously to enable the software of the image forming apparatus 100. This can be achieved through a determination of whether the enabling information stored in the license storing unit 210 of the license device 200 is equal to the enabling information stored in the storing unit 120 of the image forming apparatus 100.

In some cases, the above determination may be made by storing a serial number of the license device 200 connected to the interface 110 and comparing the serial number of the license device 200 subsequently connected to the interface 110 with the stored serial number. In other words, if the stored serial number is different from the serial number of the license device 200 currently connected to the interface 110, it may be determined that the software of the image forming apparatus 100 is not enabled by the currently connected license device 200. Accordingly, that fact may be notified, for example, to a user, and the operation to disable the software and restore the corresponding license may be ended.

In such a case, a license device 200 used to enable the software of the image forming apparatus 100 may be called a “first license device” and a license device 200 that was not used to enable the software of the image forming apparatus 100, but which may be connected to the image forming apparatus 100 at a later time, may be called a “second license device.”

For example, if the enabling information data “010” (indicating enabling information to enable only “B” of three “A,” “B” and “C” software applications) is stored in the license storing unit 210 and the same enabling information is also stored in the storing unit 120 of the image forming apparatus 100, it may be determined that the connected license device 200 is the same as the one used to enable the software of the image forming apparatus 100. In other words, the connected license device 200 is the “first license device.”

As another example, if the enabling information data “010” (enabling information to enable only “B” of three “A,” “B” and “C” software applications) is stored in the license storing unit 210 and “011” is stored as enabling information in the storing unit 120 of the image forming apparatus 100, it may be determined that the enabled “B” software of the image forming apparatus 100 is enabled by the connected license device 200.

The image forming apparatus 100 may further include a notification unit 130 as illustrated in FIG. 2. The notification unit 130 may include at least one of a speaker (not shown) to output sound, a display unit (not shown) to display visual output, an interface card (not shown) used in e-mail transmission, etc.

When the license device 200 is connected to the interface 110, the controller 160 may prompt a user through the notification unit 130 to choose whether to enable the software corresponding to the license depending on whether the license is present in the license device 200.

In more detail, if the license is present in the license device 200, the controller 160 may prompt the user through the notification unit 130 to choose whether to enable the software. On the other hand, if the license is exhausted in the license device 200, the controller 160 may prompt the user to choose whether to disable the enabled software in the image forming apparatus 100 which corresponds to the exhausted license in the license device 200.

The image forming apparatus 100 may further include an input unit 140 as illustrated in FIG. 2. After prompting and/or notifying the user regarding the enabling or disabling of the software through the notification unit 130, the software may be enabled/disabled or the enabling/disabling may be cancelled depending on a result of an input through the input unit 140.

As previously described, a plurality of software applications which can be selectively enabled may be stored in the storing unit 120 of the image forming apparatus 100, and licenses to enable at least one of the plurality of software applications may be stored in the license device 200.

If the licenses to enable the plurality of software applications are stored in the license device 200, the controller 160 may prompt the user through the notification unit 130 to choose which of the plurality of software applications to be enabled.

Then, the controller 160 may enable at least one of the plurality of software applications depending on a result of an input through the input unit 140 and may exhaust (disable) the license corresponding to the enabled software in the license device 200. That is, only the license corresponding to the enabled software among the licenses of the license device 200 may be disabled. In addition, the controller 160 may store enabling information in the storing unit 120 in association with the enabled software.

In more detail, if the license device 200 stores the plurality of software licenses, it may be configured to restore and exhaust the licenses individually. This may be achieved by assigning a storage space in such a manner that apparatus identification numbers of the licenses can be individually stored/deleted in/from the license storing unit 210 of the license device 200.

For example, there may be a case in which three software applications “A,” “B” and “C” are stored in the storing unit 120 of the image forming apparatus 100. In this case, the three software applications “A,” “B” and “C” are considered to be in an unusable disabled state at the time of shipping of the image forming apparatus 100.

If a license device 200 which may be used to enable two software applications “B” and “C” is connected to the interface 110 of the image forming apparatus 100, the controller 160 may prompt a user through the notification unit 130 to select one of the two software applications “B” and “C” to be enabled.

If the user selects the software application “B” through the input unit 140, the software application “B” may be enabled in the image forming apparatus 100 and the apparatus identification number corresponding to the license of the software application “B” may be changed from an initial value to the proper information of the image forming apparatus 100. That is, the proper information of the image forming apparatus 100 may be stored in a storage area to be used in the determination of the presence of the license of the software application “B” in the license device 200. In other words, the initial value other than the proper information of the image forming apparatus 100 is maintained, as it is, in a storage area to be used in the determination of the presence of the license of the software application “C” in the license device 200. Thus, the license of the software application “C” is retained, as it is, by the license device 200 and only the license of the software application “B” is exhausted by the license device 200.

In addition, since only the software application “B” has been enabled by the license device 200, the controller 160 may store the enabling information “010” (indicating that only “B” of the three software applications “A,” “B” and “C” is enabled) as the enabling information of the software in the storing unit 120.

On the other hand, if a license device 200 in which the plurality of software licenses is exhausted is connected to the interface 110, the controller 160 may determine whether the software which could otherwise be enabled by the exhausted licenses of the license device 200 is the same as the software enabled in the image forming apparatus 100.

If the software enabled in the image forming apparatus 100 is the same as the software normally enabled by the exhausted software licenses (that is, when the software licenses are not exhausted) of the license device 200, the controller 160 may control the notification unit 130 to prompt a user to choose whether to restore the exhausted licenses.

If the software enabled in the image forming apparatus 100 is not the same as the software normally enabled by the exhausted software licenses of the license device 200, the controller 160 may control the notification unit 130 to notify the user of that fact and may end the process.

As described above, the determination of whether the software enabled in the image forming apparatus 100 is the same as the software normally enabled by the software licenses of the license device 200 may be made by comparing the enabling information stored in the storing unit 120 of the image forming apparatus 100 with the enabling information stored in the license storing unit 210 of the license device 200.

For example, if the enabling information stored in the storing unit 120 of the image forming apparatus 100 is “011” (indicating that software applications “B” and “C” are enabled), while the enabling information stored in the license device 200 is “100” (software “A” is enabled), since the software of the image forming apparatus 100 is not enabled by the license device 200, the controller 160 determines that the software which can be enabled by the exhausted license of the license device 200 is not the same as the enabled software in the image forming apparatus 100. In this case, the controller 160 may control the notification unit 130 to notify the user of that fact (e.g., that an error has occurred) and end the process without further operation.

On the other hand, if the enabling information stored in the storing unit 120 of the image forming apparatus 100 is “011” (software applications “B” and “C” are enabled) while the enabling information of the license device 200 is “010” (only software application “B” is enabled), the controller 160 may determine that the software application “B” of the image forming apparatus 100 is enabled by the license device 200.

Accordingly, the controller 160 may control the notification unit 130 to prompt a user to choose whether to restore the license of the software “B”, and may restore the license of the software “B” according to a user selection input through the input unit 140.

As described above, the restoration of the license corresponding to software application “B” can be achieved by deleting the proper information of the image forming apparatus 100, which is stored as the apparatus proper information corresponding to the “B” software license in the license storing unit 210.

If the software which can normally be enabled by the exhausted license of the license device 200 is the same as the enabled software in the image forming apparatus 100 and there exists a plurality of software licenses equal to each other, the controller 160 may control the notification unit 130 to prompt a user to choose which license of the software applications to be restored.

Also, as previously described, the controller 160 may disable the software corresponding to a license selected by a user selection input through the input unit 140 in the image forming apparatus 100 and restore the license of the selected software.

The image forming apparatus may further include a network connection unit 170. The network connection unit 170 may be provided as a network interface card (NIC).

If the software of the image forming apparatus 100 is enabled through the license device 200, the controller 160 may control the network connection unit 170 to transmit information related to that fact to a license registration server 300 connected to the network.

In this case, the information transmitted to the license registration server 300 from the image forming apparatus 100 may include the proper information of the image forming apparatus 100 and the enabling information of the software enabled in the image forming apparatus 100. Thus, if a user loses the license device 200, the license device 200 may be reissued to the user based on the registration information stored in the license registration server 300.

In addition, the controller 160 may count the number of times of restoration of the software license. For example, the controller 160 may increment a stored value whenever the software license of the license device 200 is restored. Further, the information on the counted number of times of restoration may be stored in the license storing unit 210 of the license device 200 and/or the storing unit 120 of the image forming apparatus 100.

If the license device 200 having the exhausted software license is connected to the image forming apparatus 100, the controller 160 may disable the corresponding software and determine whether the counted number of times of restoration exceeds a predetermined value prior to restoring the software license. If the counted number of times of restoration exceeds the predetermined value, the controller 160 may control the notification unit 130 to notify a user of the fact that further restoration is not possible and then may end the process. That is, the controller 160 may not allow restoration of the disabled software license.

On the other hand, if the counted number of times of restoration is less than the predetermined value, the controller 160 may disable the enabled software and restore the disabled software license, as described above.

The controller 160 may control the notification unit 130 to notify the user of the remaining number of times by which the software license is restorable.

For example, if the maximum restorable number of times of license (corresponding to the above-mentioned predetermined value) is 4 and the total number of times by which the license has been restored up to the present is 2, the controller 160 may output a message such as, “You may restore the license twice more.” to the user by sound or vision or may transmit the message to the user's e-mail.

In some cases, the maximum restorable number of times of license may be differently set for different software applications. For example, the maximum restorable number of times of software application “A” may be set to 4, the maximum restorable number of times of software application “B” may be set to 5 and the maximum restorable number of times of software application “C” may be set to 3.

The image forming apparatus 100 of the present invention may further include a print unit 150 which forms an image on a print medium.

The print unit 150 may employ one or more of an inkjet system, an electrophotography system and a thermal transfer system which are classified depending on an image forming method.

Hereinafter, a software enabling method of the image forming apparatus 100 according to various exemplary embodiments of the present general inventive concept will be described with reference to FIGS. 2 to 5B.

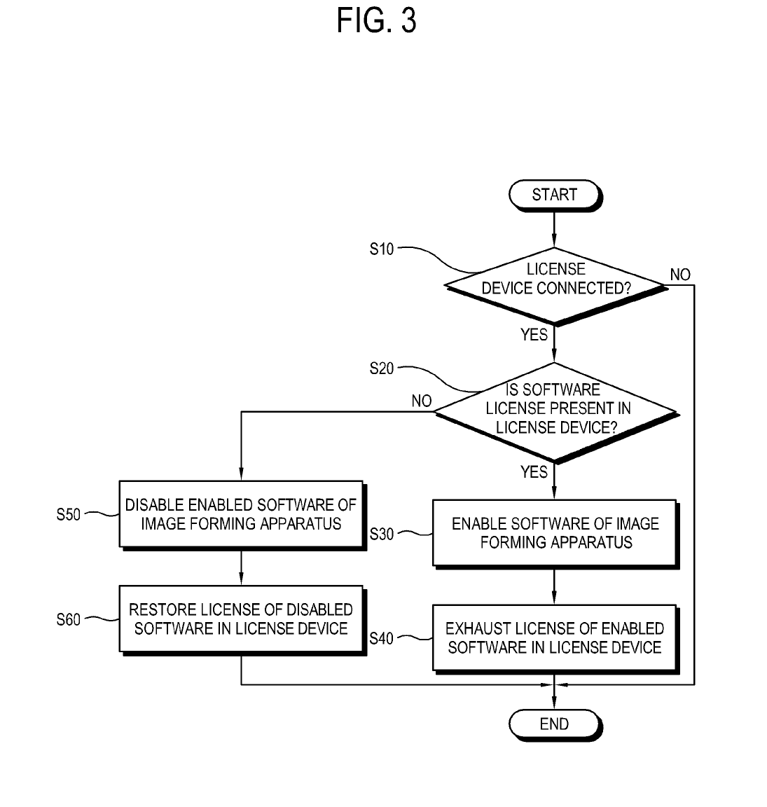

First, a software enabling method of an image forming apparatus according to an exemplary embodiment of the present general inventive concept will be described with reference to FIGS. 2 and 3. Referring to these figures, if the license device 200 is connected to the image forming apparatus 100 (YES in operation S10), it may be determined whether a license to enable the software installed in the image forming apparatus 100 is present in the license device 200 (operation S20). That is, it may be determined whether the license stored in the license device 200 is in an enable state to enable the software stored in the image forming apparatus 100.

As described earlier, if an initial value is stored as apparatus proper information in the license storing unit 210 of the license device 200, it may be determined that the license is present in the license device 200. On the contrary, if a value other than the initial value is stored as the apparatus proper information, it may be determined that the license is exhausted and not present in the license device 200.

If it is determined that the license is stored, i.e., present in the license device 200 (YES in operation S20), the software stored in a disabled state in the storing unit 120 of the image forming apparatus 100 may be enabled (operation S30).

Next, the license of the enabled software of the license device 200 may be exhausted (operation S40). That is, after enabling the software of the image forming apparatus 100, the corresponding license of the license device 200 may be disabled accordingly.

As described above, this process allows the license of the license device 200 to be exhausted by storing the proper information of the image forming apparatus 100, as the apparatus proper information, in the license device 200. That is, the license can be disabled. Of course, such a license exhaustion method (the license disabling method) is only one such example, and may be modified in various ways.

If it is determined that the license is not present in the license device 200 (NO in operation S20), that is, the license of the license device 200 has been already exhausted, the enabled software of the image forming apparatus 100 corresponding to the exhausted license may be disabled (operation S50).

In this case, the absence of the license in the license device 200 indicates that the license stored in the license device 200 is disabled. Regarding the disabling of the license, as described above, if the apparatus identification number stored in the license device 200 is not the initial value, it may be determined that the license is in the disabled state.

Next, the license of the disabled software may be restored (operation S60). That is, the disabled license may be restored to a usable state so that the license of the disabled software can be reused. Specifically, the license may be restored by deleting the proper information of the image forming apparatus 100 which is stored in the license storing unit 210 of the license device 200 and changing the proper information to the original initial state.

Although operation S50 has been described as occurring before operation S60 in this embodiment, operation S60 may occur before operation S50, or the operations may occur concurrently.

Accordingly, by restoring the previously used license in the license device 200 and reinstalling the license device 200 in the image forming apparatus 100 after repair, etc., of the image forming apparatus, or by reusing the license in an image forming apparatus (not shown) other than the initially enabled image forming apparatus 100, a user can manage the license flexibly and conveniently.

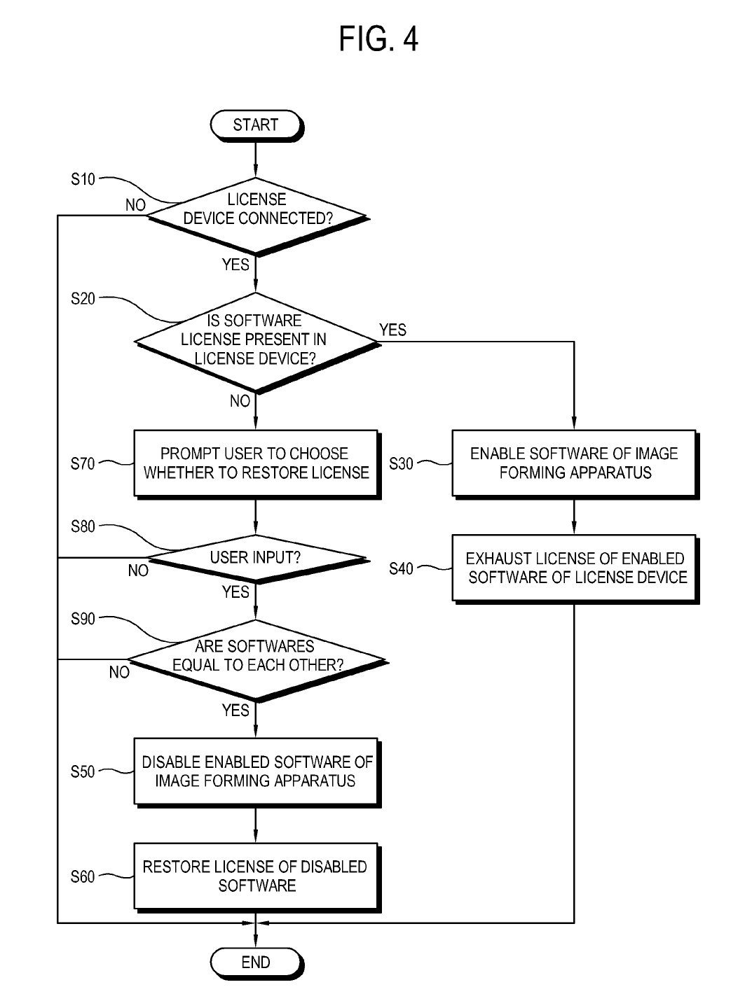

A software enabling method of an image forming apparatus according to another exemplary embodiment of the present general inventive concept will now be described with reference to FIGS. 2 and 4. This method is similar to the previously described exemplary embodiment illustrated in FIG. 3, and further includes operations S70 to S90 as illustrated in FIG. 4.

In more detail, if the license device 200 in which the license is exhausted is connected to the image forming apparatus 100 (YES in operation S10, and NO in operation S20), the software disabling operation and the license restoration operation may be automatically performed in the exemplary embodiment illustrated in FIG. 3.

However, in the exemplary embodiment illustrated in FIG. 4, an operation S70 to prompt a user to choose whether to restore the exhausted license may be further included prior to the operation S50.

Alternatively, as in performing the software disabling operation S50 and the license restoration operation S60 together, in some cases the operation S70 to prompt the user to choose whether to restore the license may be replaced with an operation to prompt the user to choose whether to disable the software.

According to a result of the prompt in operation S70, the image forming apparatus 100 may await a user's input through the input unit 140 of the image forming apparatus 100 (operation S80). In some cases, if there is no user's input for a predetermined period of time, it may be determined to input a command to restore the license as a default (YES). In some cases, conversely, it may be determined to cancel the license restoration as a default.

Next, if the user inputs a command to restore the license (YES in operation S80), it may be determined whether the software which can normally be enabled by the license device 200 having the exhausted license is equal to the enabled software of the image forming apparatus 100 (operation S90).

In some situations, there may be no need to determine whether the software applications are equal to each other, such as a case in which the number of enabled software applications stored in the storing unit 120 of the image forming apparatus 100 is one, and accordingly, the operation to determine whether both of the softwares are equal to each other (operation S90) may be omitted.

If both of the software applications are equal to each other (YES in operation S90), the enabled software of the image forming apparatus 100 may be disabled (operation S50) as previously described, and the license of the disabled software may be restored (operation S60).

If the both of the software applications are not equal to each other (NO in operation S90), an operation to notify that fact (e.g., an error has occurred) may be further included (not shown). For example, the user may be notified that an incorrect license device 200 has been connected to the image forming apparatus 100. After such a notification, the operations S50 and S60 may be omitted and the process may be ended.

It is not necessary that operations S70 and S80 and the operation S90 are performed in the described order. For instance, operation S90 may be performed before the operations S70 and S80.

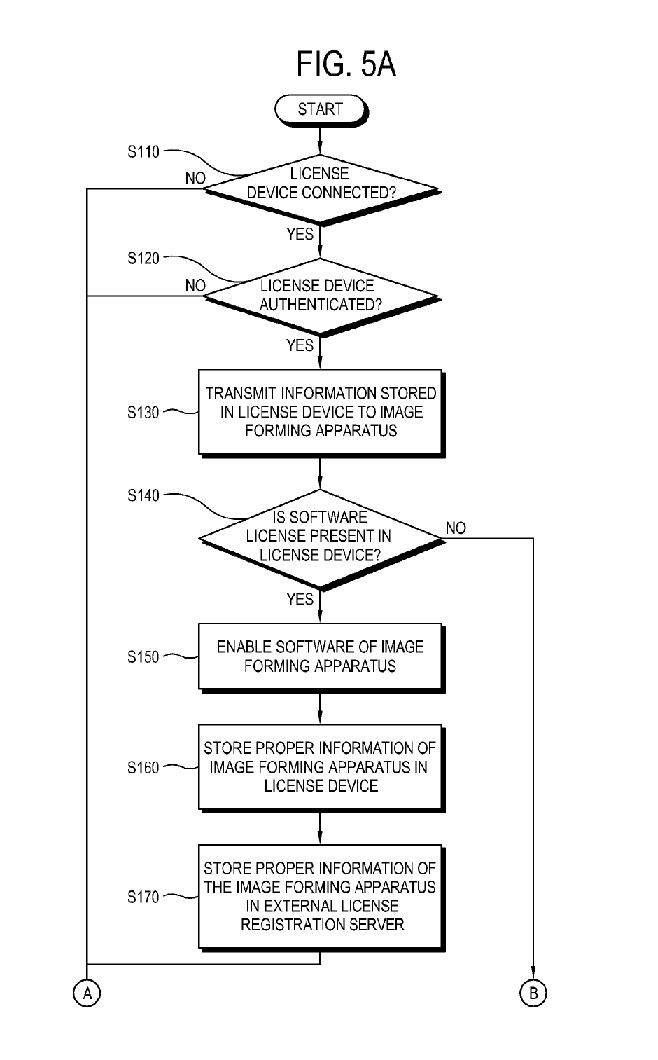

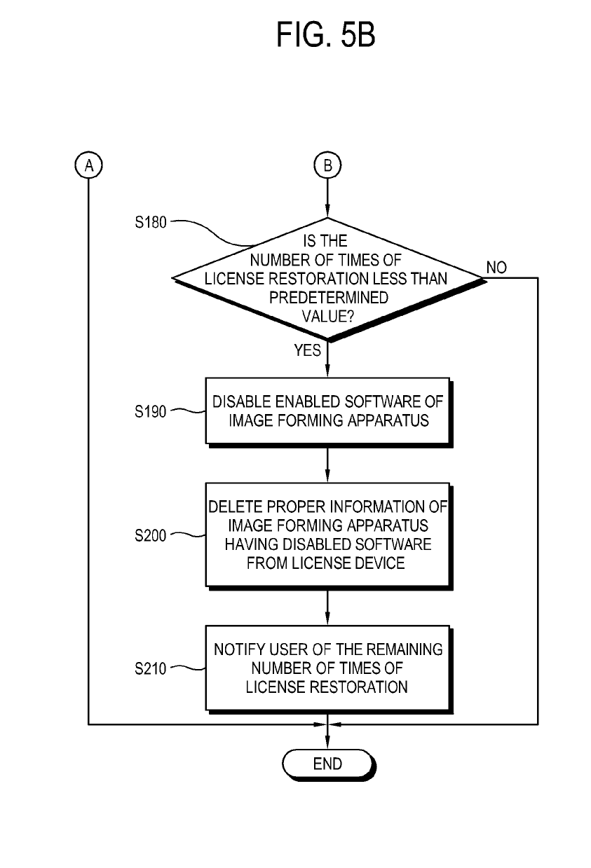

A software enabling method of an image forming apparatus according to yet another exemplary embodiment of the present general inventive concept will be described with reference to FIGS. 2, 5A and 5B.

As illustrated in FIG. 5A, the license device 200 may be connected to the image forming apparatus 100 (YES in operation S110), and the license device 200 may then be authenticated (operation S120).

The license device 200 may be authenticated by determining whether the license device 200 can conduct encrypted communication with the image forming apparatus 100. In some cases, if the license device 200 has a USB-based interface, a memory having a USB interface different from that of the license device 200 may be connected to the interface 110, and therefore, this operation S120 may determine whether a device connected to the interface 110 is the license device 200.

If the device connected to the interface 110 is the license device 200 (YES in operation S120), the information stored in the license device 200 may be transmitted to the image forming apparatus 100 (operation S130). That is, the image forming apparatus 100 may read out the license stored in the license device 200.

Next, it may be determined that a software license is present in the license device 200 (operation S140). Based on the information read from the license device 200, if a value corresponding to the apparatus proper information stored in the license device 200 is an initial value, it may be determined that the software license is present. If the apparatus proper information is not the initial value, it may be determined that the software license is exhausted, that is, not present.

If it is determined that the software license is present (YES in operation S140), the software of the image forming apparatus 100 corresponding to the software license may be enabled (operation S150).

As previously described, the software application can be enabled by updating the enabling information stored in the storing unit 120 in association with the enabled software. In more detail, the software application can be enabled by changing a value indicating a disabled state “0” to an enabled state “1” to be stored as the enabling information and enabling the software corresponding to enabled state value “1” by referring to the enabling information when the image forming apparatus 100 is powered ON. This method of indicating the enabled state in the enabling information is merely one example of storing information indicating the enabled state of the software, and may be performed in a variety of different processes. Accordingly, even when the license device 200 is not connected to the interface 110, the software can be enabled from the enabling information stored in the image forming apparatus 100.

In response to the software application being enabled as described above, the proper information of the image forming apparatus 100 may be stored in the license device 200 (operation S160).

The proper information of the image forming apparatus 100 may also be transmitted to the external license registration server 300 (operation S170). Accordingly, if a user loses the license device 200, since it can be determined whether the user is an authorized user based on the registration information stored in the license registration server 300, the license device 200 can be reissued to the user.

If the software license is not present in the license device 200 (NO in operation S140), it may be determined whether the number of times of which the license has been restored is less than a predetermined value (operation S180).

If the number of times of license restoration is less than the predetermined value (YES in operation S180), the enabled software of the image forming apparatus may be disabled (operation S190). As described above, this can be achieved by updating the enabling information stored in the storing unit 120 of the image forming apparatus 100 in association with the software to be disabled. That is, the enabling information corresponding to the software to be disabled may be changed from a value of “1” to “0” in the storing unit 120. Of course, in addition to the above described method, the software enabling/disabling method may be modified in various ways.

In response to the software being disabled in the image forming apparatus 100, the proper information of the image forming apparatus 100 having the disabled software may be deleted from the license device 200 (operation S200). Accordingly, the license of the disabled software in the image forming apparatus 100 can be restored in the license device 200.

The remaining number of times of which the license is able to be restored may then be notified to a user (operation S210).

It is not necessary to perform the operations S190 to S210 in the order described above. For example, operations S190 could be performed after operations S200 and/or S210, or the operations S190 through S210 could be performed concurrently.

If the number of times of license restoration exceeds the predetermined value (NO in operation S180), that fact may be notified to the user and the process may be ended.

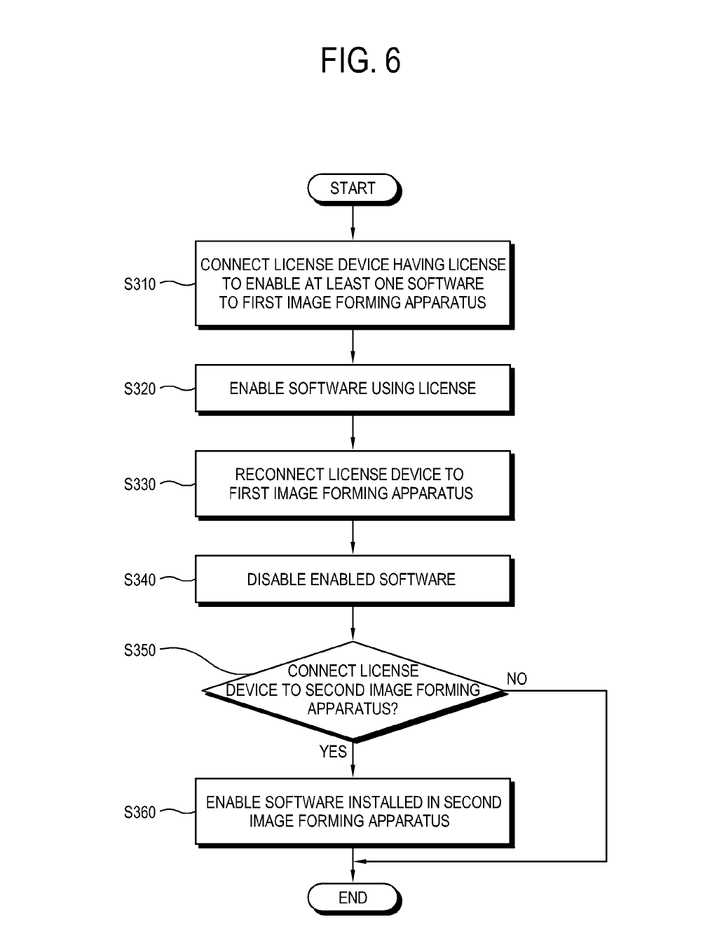

Hereinafter, a software enabling method of an image forming apparatus according to still another exemplary embodiment of the present general inventive concept will be described with reference to FIG. 6.

As illustrated in FIG. 6, a license device having a software license is connected to a first image forming apparatus (operation S310).

The license device may be provided with one license to enable one software application, or may be provided with a plurality of licenses to enable a plurality of software applications. In the case in which multiple licenses are stored in the license device, the number of licenses corresponding to the number of software applications to be enabled may be stored in the license device.

Also, in some cases, a plurality of software applications may be enabled by one license.

After the connection of the license device illustrated in operation S310, the software installed in the first image forming apparatus is enabled using the license of the license device (operation S320).

Alternatively, prior to the software enabling operation S320, a user may be prompted to choose which of the plurality of software applications to enable. Only software selected according to a user's selection after the prompting may be enabled.

In such a case, information regarding enabled and disabled states of the plurality of software applications may be indicated to the user. Accordingly, the user may select to either enable or disable a particular software application using the indicated information.

After the enabling of one or more software applications illustrated in operation S320, the license device may be reconnected to the first image forming apparatus (operation S330). For example, this reconnection of the license device may occur much later in time, such as in the event of having the first image forming apparatus repaired or replaced.

In response to the license device being reconnected to the first image forming apparatus, the enabled software of the first image forming apparatus may be disabled (operation S340). When the license device is reconnected to the first image forming apparatus, although the enabled software may be directly disabled without any inquiry of the user, as in the operation S340, the process may further include an operation to prompt the user to choose whether to disable the enabled software prior to the disabling operation S340. In such a case, if the user does not choose to disable the enabled software, the disabling operation may be cancelled and the process may be ended.

In addition, if a plurality of software applications enabled by the license device is present in the first image forming apparatus, the user may be prompted to choose which of the software application to disable. After receiving a corresponding input from the user, only software selected by the user may be disabled.

As illustrated in FIG. 6, if the license device is connected to a second image forming apparatus other than the first image forming apparatus (YES in operation S350), the software installed in the second image forming apparatus may be enabled (operation S360). In this case, the software enabled in the second image forming apparatus may correspond to the software disabled in the first image forming apparatus in the operation S340.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A method of enabling software installed in a first image forming apparatus, the method comprising:
connecting a first license device having at least one license which enables the software to the first image forming apparatus;
enabling the software using the at least one license;
reconnecting the first license device to the first image forming apparatus; and
disabling the enabled software.

2. The method according to claim 1, wherein the enabling the software and/or the disabling the enabled software is performed according to a user's selection.

3. The method according to claim 1, further comprising:
enabling software installed in a second image forming apparatus in response to the first license device being connected to a the second image forming apparatus.

4. The method according to claim 1, wherein an allowed number of times of the enabling and disabling of the software is previously determined.

5. The method according to claim 1, further comprising:
prompting a user to choose whether to enable or disable the software.

6. The method according to claim 1, further comprising:
disabling the license corresponding to the enabled software in response to the enabling the software; and
restoring the disabled license corresponding to the disabled software in response to the disabling the software.

7. The method according to claim 6, wherein the disabling the license includes storing proper information of the first image forming apparatus in the license device; and
the restoring the disabled license includes deleting the stored proper information of the
first image forming apparatus.

8. The method according to claim 6, further comprising:
notifying a user of a remaining number of times of which the license may be restored.

9. The method according to claim 1, further comprising:
registering proper information of the first image forming apparatus having the enabled software with an external license registration server via a network.

10. The method according to claim 1, further comprising:
outputting an error notification and maintaining an enabled state of the software in response to a second license device being connected to the first image forming apparatus.

11. The method according to claim 1, further comprising:
storing enable information read from the first license device in the first image forming apparatus to enable the software after the first license device is disconnected.

12. The method according to claim 11, further comprising:
erasing the enable information stored in the first image forming apparatus in response to the software being disabled.

13. The method according to claim 11, further comprising:
comparing the enable information stored in the first image forming apparatus with the enable information stored in the reconnected license device to confirm that the reconnected license device is the license device initially connected to the first image forming apparatus.

14. A method of enabling software installed in a first image forming apparatus, the method comprising:
connecting a first license device having a plurality of licenses which enable a plurality of software applications to the first image forming apparatus;
enabling one or more of the plurality of software applications;
reconnecting the first license device to the first image forming apparatus; and
disabling at least one of the enabled one or more software applications.

15. The method according to claim 14, wherein the enabling one or more of the plurality of software applications comprises:
outputting information related to the plurality of software applications;
receiving a selection of the one or more of the plurality of software applications; and
enabling the selected software applications.

16. The method according to claim 14, wherein the disabling at least one of the enabled one or more software applications comprises:
outputting information related to the one or more enabled software applications;
receiving a selection of the at least one of the enabled one or more software applications to be disabled; and
disabling the selected at least one software application.

17. The method according to claim 16, further comprising:
restoring the license corresponding to the disabled software application.

18. The method according to claim 17, wherein the restoring the license includes restoring indicating information initially recorded in the license device to indicate that the license is enabled.

19. The method according to claim 14, further comprising:
indicating enabled and disabled states of the plurality of software applications.

20. An image forming apparatus which enables software using a license device, comprising:
an interface to which the license device can be connected;
a storing unit which stores the software; and
a controller which enables the software stored in the storing unit in response to a license device having a license to enable the software being connected to the interface, and which disables the enabled software in response to the license device being reconnected to the interface.

21. The image forming apparatus according to claim 20, further comprising:
an input unit to allow a user to select whether to enable or disable the software.

22. The image forming apparatus according to claim 20, wherein the enabling or disabling of the software is disallowed in response to a number of instances of enabling or disabling the software exceeding a previously determined limit.

23. The image forming apparatus according to claim 20, further comprising:
a notification unit to prompt a user to choose whether to enable or disable the software.

24. The image forming apparatus according to claim 20, wherein the controller disables the license in response to the software being enabled, and restores the disabled license in response to the enabled software being disabled.

25. The image forming apparatus according to claim 24, wherein the controller stores proper information of the image forming apparatus in the license device in order to disable the license; and
the controller deletes the proper information of the image forming apparatus stored in the license device in order to restore the disabled license.

26. The image forming apparatus according to claim 22, further comprising:
a notification unit to notify a user as to how many remaining instances of enabling or disabling the software will be allowed.

27. The image forming apparatus according to claim 20, further comprising:
a network connection unit to transmit proper information of the image forming apparatus having the enabled software to an external license registration server.

28. The image forming apparatus according to claim 20, further comprising:
a notification unit to output an error notification in response to a different license device being connected to the image forming apparatus;
wherein the controller maintains the enabled state of the software along with controlling the notification unit to output the error notification.
